(19) United States
(12) Patent Application Publication
(10) Pub. No.: US 2012/0212679 A1
(43) Pub. Date: Aug. 23, 2012

(54) SYSTEM FOR CONTROLLING AND DISPLAYING FRAME INFORMATION DISPLAYED ON CONTROLLABLE DEVICE BY USING CONTROL DEVICE AND APPLICATION METHOD THEREOF

(76) Inventors: Ju-Yin LIN, New Taipei City (TW); Yu-Jen CHEN, New Taipei City (TW); Yuan-Hsi TSAI, New Taipei City (TW)

(21) Appl. No.: 13/093,210

(22) Filed: Apr. 25, 2011

(30) Foreign Application Priority Data
Feb. 18, 2011 (TW) 100105457

(51) Int. Cl. H04N 5/44

(52) U.S. Cl. 348/734; 348/E05.096

(57) ABSTRACT

A system for controlling and displaying frame information displayed on a controllable device by using a control device and an application method are described. The system includes a control device and a controllable device, in which the controllable device displays image information of at least one channel, and the control device in communication with the controllable device displays image information of the channel and channels adjacent to the channel on a touch screen thereof. Moreover, when the control device receives a gesture signal, the controllable device processes the gesture signal and performs a preset function corresponding to the gesture signal. By using the system and the application method thereof, diversified control modes are provided to the user, and the user can remotely control the controllable device through a simple operation.

### CROSS-REFERENCE TO RELATED APPLICATIONS

This non-provisional application claims priority under 35 U.S.C. §119(a) on Patent Application No(s). 100105457 filed in Taiwan, R.O.C. on Feb. 18, 2011, the entire contents of which are hereby incorporated by reference.

### BACKGROUND OF THE INVENTION

1. Field of Invention

The present invention relates to a system having a control device and a controllable device and an application method thereof, and more particularly to a system for controlling a controllable device via a gesture signal on a control device and synchronously displaying frame information displayed on the controllable device by the control device and an application method thereof.

2. Related Art

Television is widely used in daily life of modern people, and has become an indispensable entertainment media. Films, dramas, music performance, and ball games can be played on a television. For many people, watching television is a habit in their life. For example, people can watch television while having a meal or during leisure time, or even watch news programs before leaving home to know about the current weather and traffic situation.

A television remote controller is basic equipment, which is provided with almost each television. People can change television channels, adjust volume, and switch power of the television by using the television remote controller. Most of the television remote controllers work by manual. In particular, a plurality of keys or buttons is disposed on the television remote controller for a user to touch and press. When a key or button on the television remote controller is pressed, the internal motherboard with integrated circuits (IC) thereof sends a signal to a sensor at the television terminal through infrared rays. Thereby, the user can change the television channels or control the volume of the television.

However, conventional television remote controllers are the most essential button-pressing type controllers such that a user must press a correct channel number or volume key to enable the television to perform a correct corresponding function. When the user is somewhat distracted or presses an incorrect button, the television responds with a wrong reaction, thereby bringing the user inconvenience in use.

Moreover, with the fast development of information, the number of television channels increases gradually. Accordingly, people also have more choices. In the conventional method of watching television, it is difficult for the user to know what programs are played on other channels at the same time, and the user must change the channels one by one to watch the programs played on other channels, thereby bringing inconvenience in use.

Therefore, it is an urgent topic for persons in the industry to solve the problems in the prior art and to provide a simple method for remotely controlling the television.

### SUMMARY OF THE INVENTION

Accordingly, the present invention provides a control method for controlling a controllable device by using a control device and a method for displaying frame information displayed on the controllable device by using the control device and systems thereof, to address the issues in the prior art.

The present invention provides a control method for controlling a controllable device by using a control device having a touch screen, where the control method comprises: receiving a gesture signal, in which the gesture signal is input to the touch screen of the control device through an indication object, and the gesture signal is a numeric symbol; processing the gesture signal and converting the gesture signal into a channel signal; and displaying a channel list associated with the numeric symbol according to the channel signal.

According to an embodiment of the present invention, the controllable device can display a channel list comprising all channels having channel numbers starting with the numeric symbol.

The present invention also provides an information displaying method for displaying frame information displayed on a controllable device by using a control device having a touch screen, where the information displaying method comprises: transmitting image information of at least one channel to the control device, in which the image information of the channel is displayed on the controllable device; and displaying the image information of the channel and image information of channels adjacent to the channel on the touch screen at the same time.

According to an embodiment of the present invention, the control device has a first use position and a second use position, and when the control device rotates from the first use position to the second use position, the image information displayed on the control device turns a specific angle.

According to an embodiment of the present invention, the image information of the channel comprises a channel name and a channel number of the played channel and an image frame played currently.

According to an embodiment of the present invention, the information displaying method further comprises a step of receiving a gesture slide signal to change a channel currently displayed on the control device to an adjacent channel.

According to an embodiment of the present invention, the control device is connected to the controllable device through wireless communication.

The present invention further provides a display system comprising a control device and a controllable device. The controllable device displays image information of at least one channel. The control device is communicatively connected to the controllable device and has a touch screen. The touch screen of the control device displays the image information of the channel displayed on the controllable device and image information of channels adjacent to the channel at the same time.

Therefore, according to the control device and the controllable device communicatively connected with each other in the present invention, a user can input different gesture signals on the control device to achieve the purpose of controlling various operating functions of a terminal device (for example, the controllable device).

Moreover, according to the control device and the controllable device of the present invention, the control device having the touch screen can further display image information currently played on the terminal device (for example, the controllable device) and image information of channels adjacent to the channel played on the terminal device at the same time, thereby improving the industrial applicability of the control device greatly.

### BRIEF DESCRIPTION OF THE DRAWINGS

The present invention will become more fully understood from the detailed description given herein below for illustration only, and thus are not limitative of the present invention, and wherein:

FIG. 1 is a schematic view illustrating the system of a control system according to a first embodiment of the present invention;

FIG. 2 is a flow chart of steps for the control device according to FIG. 1 to control a controllable device;

FIG. 3 is a schematic view illustrating the system of a control system according to FIG. 1 for controlling the controllable device according to a gesture signal;

FIGS. 4A to 4E are schematic views illustrating the system of the control system according to FIG. 1 for controlling the controllable device according to simple geometrical symbols;

FIG. 4F is a schematic view illustrating the system of the control system according to FIG. 1 for controlling the controllable device according to English letters;

FIG. 5 is a schematic view illustrating the system of a display system according to a second embodiment of the present invention;

FIG. 6 is a flow chart of steps for a control device according to FIG. 5 to display frames and information of a channel;

FIG. 7 is a schematic view of a displayed image when the control device according to FIG. 5 is at a first use position;

FIG. 8 is a schematic view of a displayed image when the control device according to FIG. 5 is at a second use position; and

FIG. 9 is a schematic view of a displayed image after the control device according to FIG. 5 receives a gesture slide signal.

### DETAILED DESCRIPTION OF THE INVENTION

The detailed features and advantages of the present invention are described below in great detail through the following embodiments, the content of the detailed description is sufficient for persons skilled in the art to understand the technical content of the present invention and to implement the present invention there accordingly. Based upon the content of the specification, the claims, and the drawings, persons skilled in the art can easily understand the relevant objectives and advantages of the present invention.

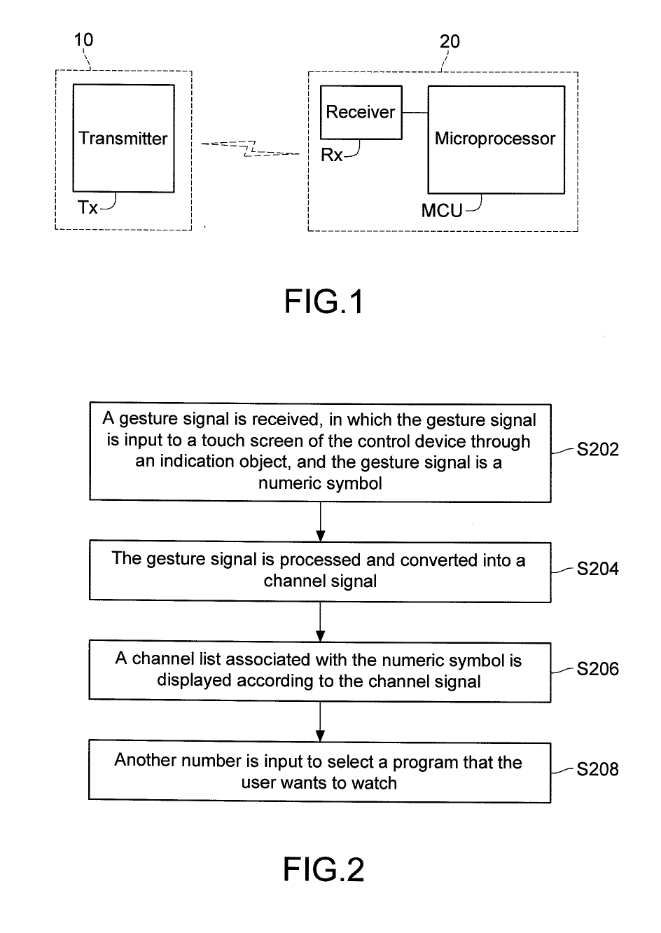

FIG. 1 is a schematic view illustrating the system of a control system according to a first embodiment of the present invention. The control system comprises a control device 10 and a controllable device 20, in which the control device 10 may be, but is not limited to, a television remote controller, the controllable device 20 may be a television display device, and the controllable device 20 can be used to display image frames provided from a source selected from, but not limited to, a content provider, a multimedia on demand system and etc.

The control device 10 is mainly connected to the controllable device 20 through wireless communication. For example, the control device 10 has a transmitter Tx, and thereby the control device 10 can send a wireless signal through synchronous transmission of infrared rays, microwave transmission or wireless radio frequency (RF) transmission. The controllable device 20 has a receiver Rx corresponding to the transmitter Tx to receive the wireless signal sent by the control device 10.

The controllable device 20 has a microprocessor MCU, in which the microprocessor MCU is electrically connected to the receiver Rx and is used to process the wireless signal sent by the control device 10 to enable the controllable device 20 to perform a corresponding function. The details about controlling the controllable device 20 by using the control device 10 are described as follows with reference to the flow chart of FIG. 2.

FIG. 2 is a flow chart of steps for the control device according to FIG. 1 to control the controllable device. The control method is applicable to the controllable device 20 and comprises the following steps.

In Step S202, a gesture signal is received, in which the gesture signal is input to a touch screen of the control device through an indication object, and the gesture signal is a numeric symbol.

In Step S204, the gesture signal is processed and converted into a channel signal.

In Step S206, a channel list associated with the numeric symbol is displayed according to the channel signal.

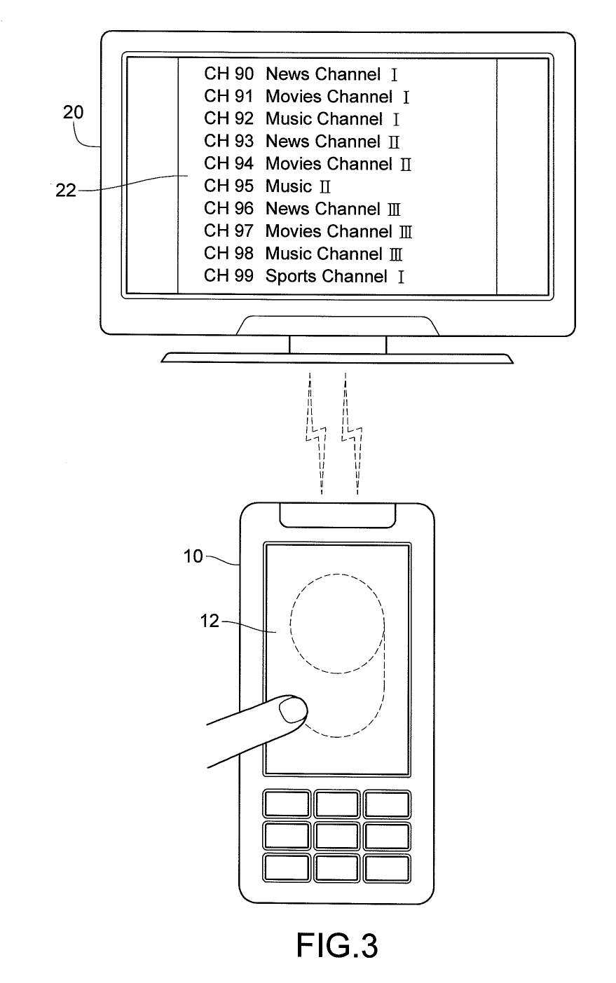

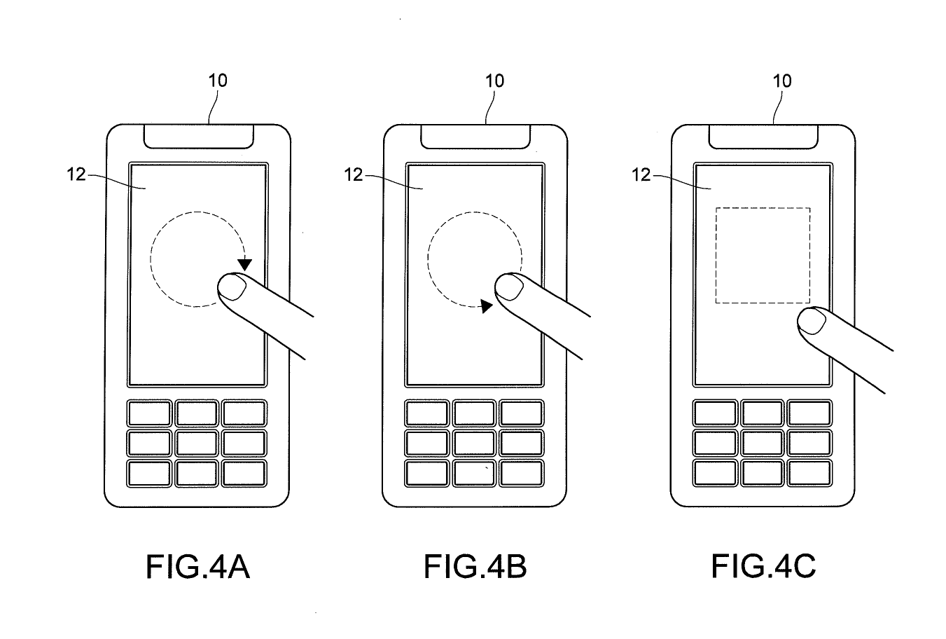

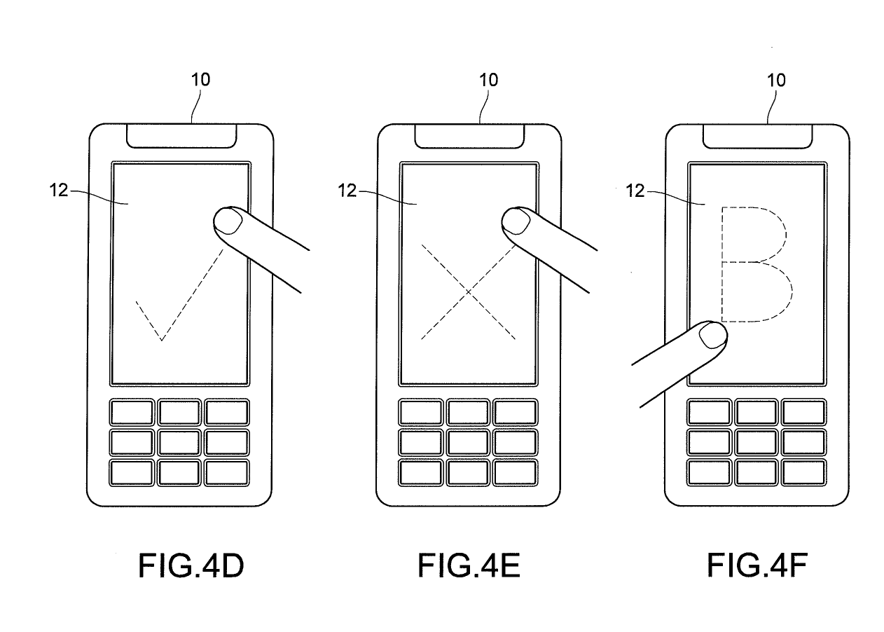

Referring to FIG. 3, the control device 10 has a touch screen 12, for example, an optical touch monitor (OTM), to receive the gesture signal. The gesture signal can be input by a user to the touch screen 12 through the indication object such as a finger tip or a touch stylus. It should be noted that, in this embodiment, the numeric symbol is taken as an example of the gesture signal. In other embodiments of the present invention, the gesture signal may also be text, a simple geometrical symbol or other patterns such as English letters, as shown in FIGS. 4A to 4F.

In particular, when the control device 10 receives the gesture signal input to the touch screen 12 through the indication object and the gesture signal is the numeric symbol, the control device 10 wirelessly transmits the gesture signal to the controllable device 20 through the transmitter Tx thereof. Then, the controllable device 20 receives the gesture signal through the receiver Rx and processes the gesture signal by using the microprocessor MCU, so as to convert the gesture signal into a channel signal. Herein, the controllable device 20 can display the channel list associated with the numeric symbol on a display screen 22 thereof.

For example, when the gesture signal input by the user is 9, the controllable device 20 can display the channel list comprising all channels having channel numbers starting with 9, including channel names and channel numbers of channels 90, 91, 92, 93, 94, 95, 96, 97, 98, 99, so that the user can decide (or select) one channel to watch. According to an embodiment of the present invention, as shown in Step S208, only after the controllable device 20 displays the channel list associated with the numeric symbol input by the user, the user can further input another number with reference to the channel list displayed on the controllable device 20 to select a program that the user wants to watch. For example, when the gesture signal input by the user is 9, the controllable device 20 displays the channel names and channel numbers of channels 90, 91, 92, 93, 94, 95, 96, 97, 98, 99. After that, the user inputs 6, and then the controllable device 20 is controlled to change to the channel 96, so as to play frame information of the channel 96.

FIGS. 4A to 4F are schematic views illustrating the system of the control system according to FIG. 1 for controlling the controllable device according to simple geometrical symbols and English letters respectively. The gesture signal may be a clockwise or counterclockwise pattern shown in FIGS. 4A and 4B, geometrical symbols such as a rectangle, a tick (√) and a cross (x) shown in FIGS. 4C, 4D and 4E, or the English letter (B) shown in FIG. 4F.

For example, when the controllable device 20 is used to play a film or perform a recording function, the user can control the corresponding function performed by the controllable device 20 according to a self-defined gesture signal. For example, when the gesture signal is the clockwise pattern, a media playing system of the controllable device 20 performs fast-forwarding function; when the gesture signal is the counterclockwise pattern, the media playing system of the controllable device 20 performs rewind function. When the gesture signal is the geometrical symbol such as the rectangle, the tick (√) or the cross (x), the media playing system of the controllable device 20 performs pause, starting recording or cancelling function accordingly. When the gesture signal is the English letter B, the controllable device 20 starts on-screen display for the user to modulate the brightness of a screen. The gesture signal and the corresponding function performed by the controllable device 20 are not intended to limit the scope of the present invention. The user or product designer can set the gesture signal and the corresponding function performed by the controllable device 20 according to his/her preference or product specification, to greatly expand the application scope of the control system provided by the present invention.

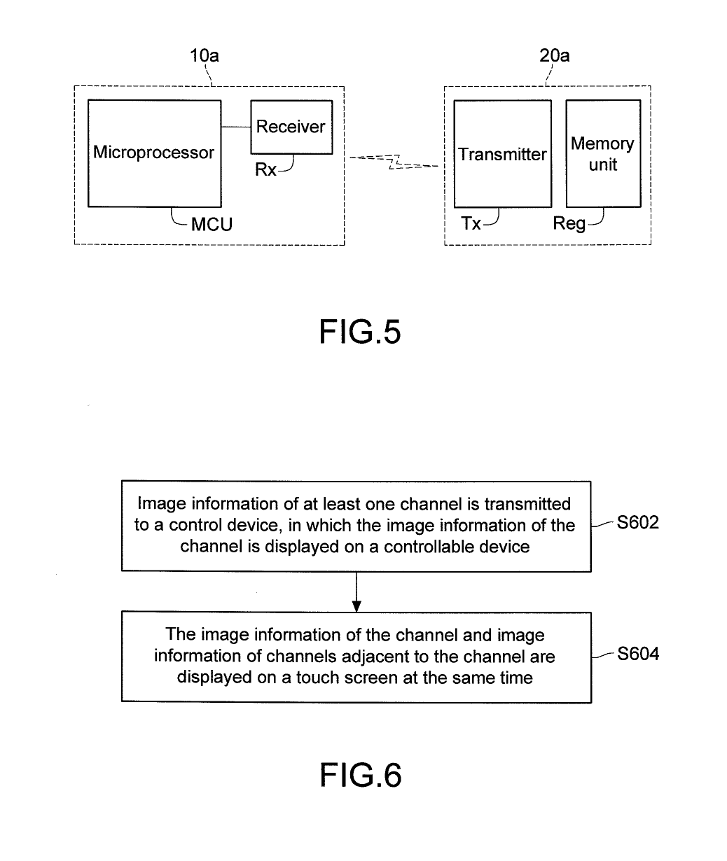

FIG. 5 is a schematic view illustrating the system of a display system according to a second embodiment of the present invention. The display system comprises a control device 10a and a controllable device 20a, in which the control device 10a may be, but is not limited to, a television remote controller, and the controllable device 20a may be, but is not limited to, a television display device.

The controllable device 20a is mainly connected to the control device 10a through wireless communication. For example, the controllable device 20a has a memory unit Reg and a transmitter Tx. When the controllable device 20a receives image information provided from a content provider or a multimedia on demand system through a communication antenna or other coaxial cables, the image information can be temporarily stored in the memory unit Reg in the form of successive single frames. Then, the controllable device 20a transmits the frames of the image information to the control device 10a through the transmitter Tx. Here, the transmitter Tx transmits the frames of the image information to the control device 10a one by one through synchronous transmission of infrared rays, microwave transmission or wireless RF transmission.

The control device 10a has a receiver Rx corresponding to the transmitter Tx. Thereby, the control device 10a can receive the image information transmitted by the controllable device 20a. The control device 10a also has a microprocessor MCU, in which the microprocessor MCU is electrically connected to the receiver Rx and is used to process the frames transmitted by the controllable device 20a, so that the control device 10a can display the image information accordingly. The details about displaying the frame information displayed on the controllable device 20a by using the control device 10a are described as follows with reference to the flow chart shown in FIG. 6.

FIG. 6 is a flow chart of steps for the control device according to FIG. 5 to display frames and information of a channel. The display method is applicable to the control device 10a, and comprises the following steps.

In Step S602, image information of at least one channel is transmitted to the control device, in which the image information of the channel is displayed on the controllable device.

In Step S604, the image information of the channel and image information of adjacent channels are displayed on a touch screen at the same time.

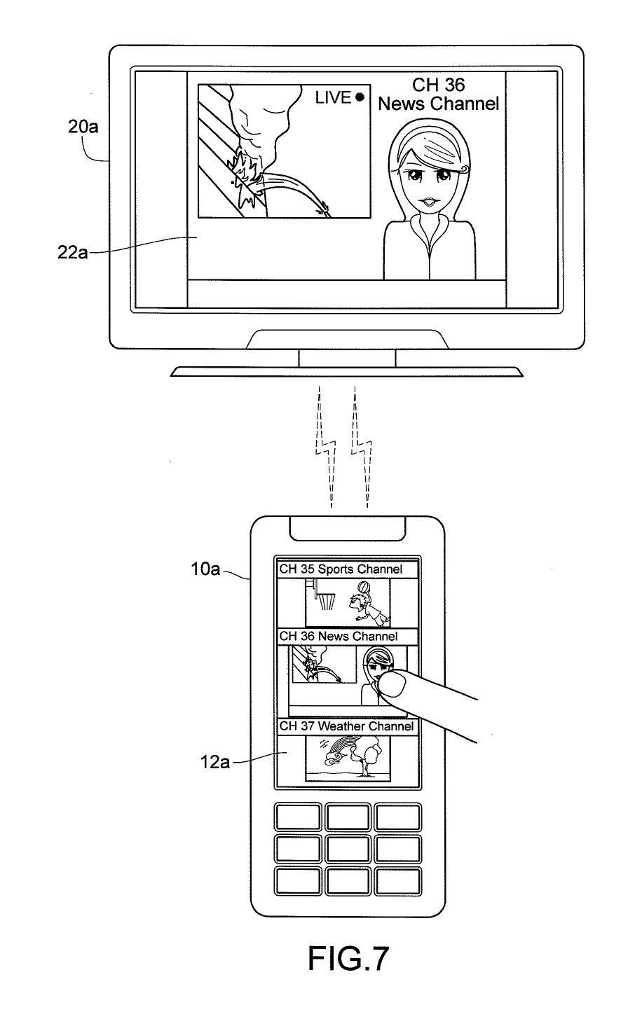

Referring to FIG. 7, the controllable device 20a has a display screen 22a, for displaying the image information of at least one channel from the content provider or multimedia on demand system, in which the image information comprises a channel name, a channel number of a played channel and an image frame played currently (for example, channel 36 is playing weather reports).

The control device 10a is communicatively connected with the controllable device 20a, and has a touch screen 12a, for example, an optical touch monitor (OTM). Thereby, when the controllable device 20a receives image information of channels from the content provider or multimedia on demand system, and the frames of the image information are temporarily stored in the memory unit Reg one by one, the controllable device 20a can transmit the frames of the channels to the control device 10a one by one through the transmitter Tx, so that the microprocessor MCU of the control device 10a can parse the frames and present the image information of the channels on the touch screen 12a.

For example, when a user is watching channel 36 displayed on the controllable device 20a, the control device 10a can display image information of channel 36 and channels adjacent to channel 36 (comprising channels 35 and 37) at the same time on the touch screen 12a thereof through wireless communication between the controllable device 20a and the control device 10a. The image information comprises channel names, channel numbers and image frames played currently (for example, breaking news is played on channel 36, weather information is played on channel 35, and sport games are played on channel 37).

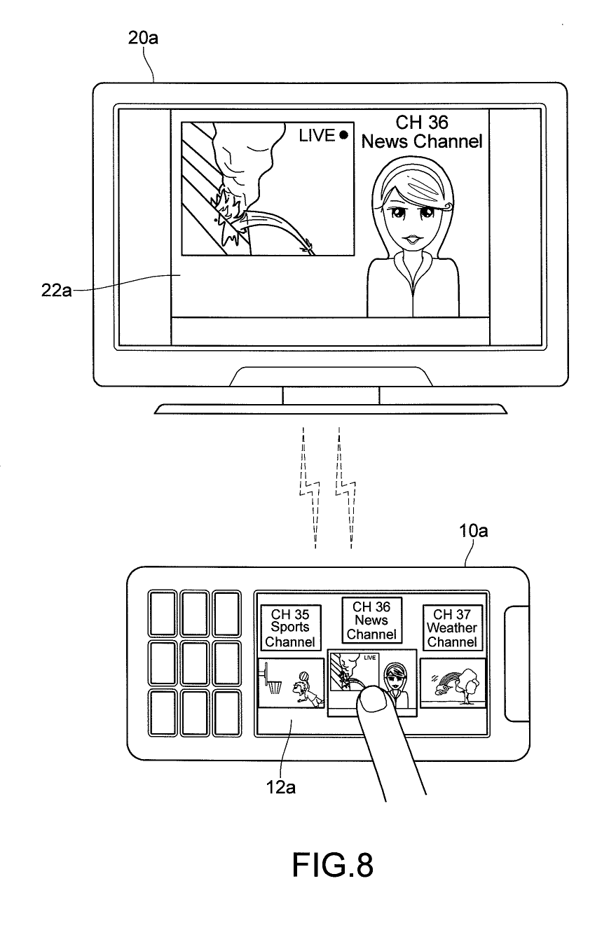

According to the second embodiment of the present invention, since the control device 10a can generally be held by the user in a vertical or horizontal direction, a first use position shown in FIG. 7 and a second use position shown in FIG. 8 are formed. Therefore, in the display system of the present invention, when the control device 10a rotates from the first use position to the second use position, the image information displayed on the control device 10a turns a specific angle (for example, vertically turns 90 degrees) for the user to watch.

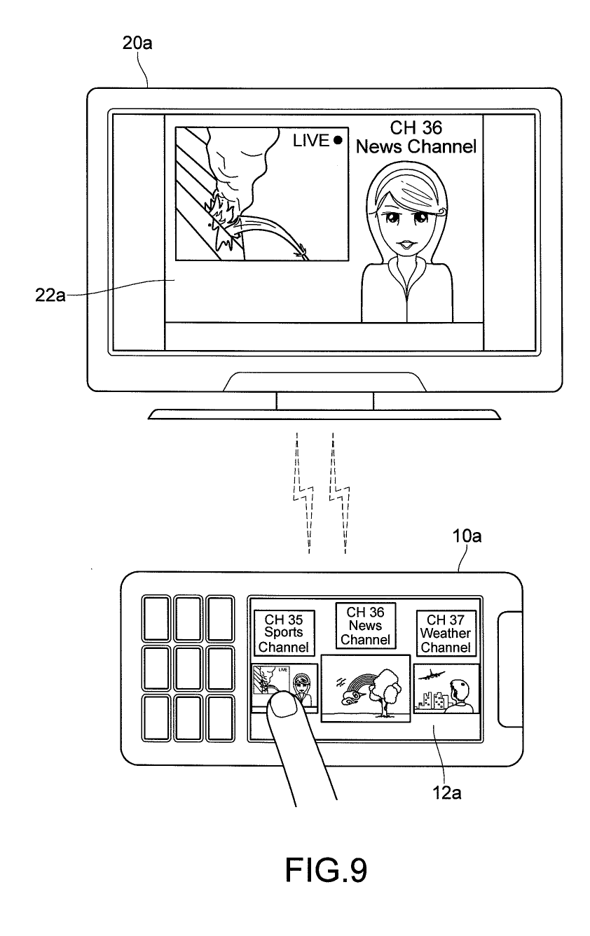

FIG. 9 is a schematic view of a displayed image after the control device according to FIG. 5 receives a gesture slide signal. As shown in FIG. 9, when the user inputs a gesture slide signal on the touch screen 12a of the control device 10a, the control device 10a may accordingly change a displayed channel to a channel adjacent to the current one. For the embodiment in FIG. 8, when the user inputs a leftward slide signal, the control device 10a displays image information of channel 37 and adjacent channels thereof (comprising channel 36 and channel 38). Thereby, the user can decide (or select) a channel to watch with reference to the image information of the channels displayed on the control device 10a, so that the controllable device 20a can be switched to the selected channel and plays the content that the user wants to watch.

Therefore, to sum up, the present invention provides a method for controlling the controllable device by using the control device having the touch screen and the control system thereof, for controlling functions performed by a terminal device (for example, the controllable device) according to different gesture signals on the control device.

According to the control method and control system thereof, diversified control modes are achieved through different gestures input by the user, the operation mode is simple and intuitive, and the control method and control system are convenient for the user to use.

The present invention also provides the method for displaying the frame information displayed on the controllable device by using the control device and the display system thereof, for synchronously displaying the image information played on a terminal device (for example, the controllable device) by using the control device. Thereby, according to the display method and the display system thereof of the present invention, diversified and convenient channel selection is additionally provided to the user, and the application scope of the control device is greatly expanded.

What is claimed is:

1. A control method, for controlling a controllable device by using a control device having a touch screen, comprising:
receiving a gesture signal, wherein the gesture signal is input to the touch screen of the control device through an indication object, and the gesture signal is a numeric symbol;
processing the gesture signal and converting the gesture signal into a channel signal; and
displaying a channel list associated with the numeric symbol according to the channel signal.

2. The control method according to claim 1, wherein the controllable device displays the channel list comprising all channels having channel numbers starting with the numeric symbol.

3. An information displaying method, for displaying frame information displayed on a controllable device by using a control device having a touch screen, comprising:
transmitting image information of at least one channel to the control device, wherein the image information of the channel is displayed on the controllable device; and
displaying the image information of the channel and image information of channels adjacent to the channel on the touch screen at the same time.

4. The information displaying method according to claim 3, wherein the control device has a first use position and a second use position, and when the control device rotates from the first use position to the second use position, the image information displayed on the control device turns a specific angle.

5. The information displaying method according to claim 3, wherein the image information of the channel comprises a channel name and a channel number of the played channel and an image frame played currently.

6. The information displaying method according to claim 3, further comprising a step of receiving a gesture slide signal to change the channel being currently displayed on the control device to an adjacent channel.

7. The information displaying method according to claim 3, wherein the control device is connected to the controllable device through wireless communication.

8. A display system, comprising:
a controllable device, for displaying image information of at least one channel; and
a control device, communicatively connected to the controllable device and having a touch screen,
wherein the touch screen of the control device displays the image information of the channel and image information of channels adjacent to the channel at the same time.

9. The display system according to claim 8, wherein the control device has a first use position and a second use position, and when the control device rotates from the first use position to the second use position, the image information displayed on the control device turns a specific angle.

10. The display system according to claim 8, wherein the image information of the channel comprises a channel name and a channel number of the played channel and an image frame played currently.

11. The display system according to claim 8, wherein when the control device receives a gesture slide signal, the control device changes the channel being currently displayed to an adjacent channel.

12. The display system according to claim 8, wherein the control device is connected to the controllable device through wireless communication.
